(19) United States
(12) Patent Application Publication
(10) Pub. No.: US 2026/0198436 A1
(43) Pub. Date: Jul. 16, 2026

(54) AUTONOMOUS HYDROPONIC SEED GERMINATION SYSTEM, COMPONENTS THEREOF, AND METHOD OF OPERATION THEREFOR

(71) Applicant: BACCARA VERTICAL FARMS AGRICULTURAL COOPERATIVE SOCIETY LTD, Kfutzat Geva (IL)

(72) Inventors: Sharon SHULSHTAIN, Kibbutz Gazit (IL); Eran BENIAMINI, Kfar Yehezkel (IL); Liav FITOUSSI, Kibbutz Maoz Haim (IL)

(21) Appl. No.: 19/102,995

(22) PCT Filed: Aug. 14, 2023
(86) PCT No.: PCT/IL2023/050855

§ 371 Date: Feb. 11, 2025

(30) Foreign Application Priority Data
Aug. 16, 2022 (IL) 295689

(51) Int. Cl. A01G 31/06; A01G 9/029

(52) U.S. Cl. CPC A01G 31/06; A01G 9/0293

(57) ABSTRACT

An autonomous hydroponic seed germination system (AHSGS) for hydroponically germinating seed in seed germination trays to sprout produce. The AHSGS includes a climate-controlled automated hydroponic seed germination enclosure having a hydroponic seed germination chamber and at least one shuttle, a work cell including at least one robot having an articulated arm for securely clamping a seed germination tray, and a workstation for enabling an operator to set operating parameters for the AHSGS and monitor its operation.

### FIELD OF THE INVENTION

The invention relates to automated hydroponic seed germination systems.

### BACKGROUND OF THE INVENTION

Automated hydroponic seed germination systems afford cost efficient, footprint efficient, manpower efficient, and environmentally considerate seed germination to sprout produce for human consumption and/or livestock consumption.

### SUMMARY OF THE INVENTION

The present invention is directed towards an autonomous hydroponic seed germination system, components thereof, and method of operation therefor for hydroponically germinating seed in seed germination trays to sprout produce for human consumption and/or livestock consumption.

The autonomous hydroponic seed germination system employs seed germination trays for germinating fresh seed to sprout produce. The seed germination trays are optionally generally rectangular shaped and 1 m by 1 m square. Seed germination trays are configured for being securely clamped for manipulation purposes by a robot's articulated arm and an automated hydroponic seed germination enclosure's shuttle. The seed germination trays are optionally divided into at least four seed germination tray sub-areas and include a drainage arrangement for draining excess irrigation water therefrom. The drainage arrangement is optionally configured as an array of throughgoing bores.

The autonomous hydroponic seed germination system includes a climate-controlled automated hydroponic seed germination enclosure resembling an automated storage and retrieval system (AS/RS) for hydroponically germinating seeds in seed germination trays to sprout produce, a work cell including at least one robot and a workstation for enabling an operator to set operating parameters for the autonomous hydroponic seed germination system and monitor its operation, the workstation including a controller simultaneously controlling the automated hydroponic seed germination enclosure and the work cell.

The climate-controlled automated hydroponic seed germination enclosure includes a hydroponic seed germination chamber having at least one spaced apart pair of parallel seed germination tray racks with at least four shelves heightwise and configured for receiving a multitude of seed germination trays therealong. The automated hydroponic seed germination enclosure includes at least one shuttle displaceable along a shuttle rail between the seed germination tray racks for placing seed germination trays with fresh seed on seed germination tray shelves and removing seed germination trays with sprout produce from seed germination tray shelves after a predetermined seed germination period. The seed germination chamber includes the following arrangements: an illumination arrangement for illuminating seed germination trays, an irrigation arrangement for irrigating seed germination trays, and a drainage arrangement for draining excess irrigation from seed germination trays. The seed germination chamber maintains the following climate parameters for optimal seed germination: temperature from about 20° C. to about 25° C., humidity from about 65% to about 90%, CO₂ concentration from about 500 ppm to about 1,500 ppm, and wind speed therealong from about 0.5 msec⁻¹ to about 2 msec⁻¹.

The work cell includes at least one robot with an articulated arm for securely clamping a seed germination tray for manipulation purposes. A robot transfers seed germination trays with fresh seed to the automated hydroponic seed germination enclosure for seed germination purposes. The seed germination trays with fresh seed can be pre-prepared or alternatively prepared in situ at the work cell. A robot preferably empties sprout produce from seed germination trays by inverting seed germination trays whereupon their sprout produce is gravitationally emptied therefrom by virtue of its weight. The robot preferably inserts seed germination trays after being emptied of their sprout produce into a washing station for washing and disinfecting ready for re-filling with fresh seed.

For optimal efficiency, a robot preferably continuously securely clamps a seed germination tray and executes the following steps: lifting a seed germination tray with sprout produce, inverting the seed germination tray to gravitationally empty its sprout produce at a sprout produce station, inserting the seed germination tray into a washing station for washing and disinfection, removing the washed and disinfected seed germination tray from the washing station, holding the seed germination tray under a fresh seed doser for dosing at least one fresh seed dose thereon, and repeatedly and rapidly agitating the seed germination tray in a X-Y horizontal plane for flattening the at least one fresh seed dose for evenly spreading fresh seed over the seed germination tray. The handling time of a seed germination tray by a robot is relatively insignificant compared to a seed germination period for hydroponically germinating seed to sprout produce.

The autonomous hydroponic seed germination system preferably includes a seed germination tray buffer between the automated hydroponic seed germination enclosure and the work cell for facilitating transfer of seed germination trays therebetween. The seed germination tray buffer can be implemented by, for example, a motorized inbound conveyor for transporting seed germination trays with fresh seed from the work cell to the automated hydroponic seed germination enclosure and a motorized outbound conveyor for transporting seed germination trays with sprout produce from the automated hydroponic seed germination enclosure to the work cell, a motorized carousel similar to an airport luggage carousel, a seed germination tray rack for holding a stack of seed germination trays, and the like.

The autonomous hydroponic seed germination system preferably includes a fresh seed station for in situ preparing seed germination trays with fresh seed. The fresh seed station includes a fresh seed doser for dosing fresh seed doses of predetermined weight. Fresh seed doses typically have a mound-like appearance. A robot securely clamping a seed germination tray under the fresh seed doser, preferably repeatedly and rapidly agitates a seed germination tray in a X-Y horizontal plane to flatten fresh seed doses for evenly spreading fresh seed over the seed germination tray.

The climate-controlled automated hydroponic seed germination enclosure optionally includes a standalone climate-controlled seed imbibition station. The seed imbibition station includes a seed germination tray rack for accommodating seed germination trays with fresh seeds for imbibing seeds ready for transferring to the hydroponic seed germination chamber. The seed imbibition station includes spray devices for creating a near 100% humid mist in a near sealed enclosed environment for uptake of water equivalent to soaking fresh seeds in water. Seed germination trays are placed on seed germination tray racks in the seed imbibition station and removed therefrom by a shuttle in the same manner as in the hydroponic seed germination chamber.

A shuttle optionally includes one or more climate sensors for monitoring climate conditions at different locations in the hydroponic seed germination chamber for enabling detection of a possible malfunction in the illumination arrangement, the irrigation arrangement, etc. The climate sensors include one or more of: a humidity sensor, a temperature sensor, a CO₂ sensor and an anemometer. A shuttle optionally includes a photometer for monitoring light at different locations in the hydroponic seed generating chamber.

The autonomous hydroponic seed germination system preferably includes a weighing machine for weighing the sprout produce of the seed germination trays. The weighing machine preferably records the weight of sprout produce of each seed germination tray at the workstation for monitoring purposes.

The autonomous hydroponic seed germination system can optionally include one or more cameras for imaging sprout produce for monitoring seed germination.

### BRIEF DESCRIPTION OF DRAWINGS

In order to understand the present invention and to see how it can be carried out in practice, preferred embodiments will now be described, by way of non-limiting examples only, with reference to the accompanying drawings, in which similar parts are likewise numbered, and in which:

FIG. 1 is a schematic view of an autonomous hydroponic seed germination system;

FIG. 2 is a schematic diagram of the autonomous hydroponic seed germination system;

FIG. 3 is a schematic view of a fresh seed station;

FIG. 4 is a schematic view of an automated hydroponic seed germination enclosure;

FIG. 5 is a longitudinal cross section of the automated hydroponic seed germination enclosure along line A-A in FIG. 4;

FIG. 6A is a schematic view of a seed germination tray rack and a shuttle;

FIG. 6B is an end view of a spaced apart pair of seed germination tray racks and a shuttle;

FIG. 7 is a close-up schematic view of a section of a seed germination tray shelf;

FIG. 8 is a schematic view of the shuttle including a seed germination tray carriage;

FIG. 9 is a schematic view of a seed imbibition station of the automated hydroponic seed germination enclosure;

FIG. 10 is a schematic view of a work cell including a robot, an inbound conveyor; an outbound conveyor, a sprout produce station and a washing station;

FIG. 11 is a schematic view of the work cell's robot;

FIG. 12 is a front schematic view of the work cell's washing station;

FIG. 13A is a top schematic view of a seed germination tray;

FIG. 13B is a bottom schematic view of FIG. 13A's seed germination tray;

FIG. 14 is a partially exploded bottom schematic view of FIG. 13A's seed germination tray;

FIG. 15 is a schematic view of FIG. 11's robot securely clamping a seed germination tray;

FIG. 16A is a schematic view of FIG. 11's robot securely clamping a seed germination tray with four fresh seed doses;

FIG. 16B is a schematic view of FIG. 11's robot securely repeatedly and rapidly agitating the FIG. 16A's seed germination tray in a X-Y horizontal plane to evenly spread the four fresh seed doses;

FIG. 16C is a schematic view of FIG. 11's robot inverting a seed germination tray for gravitationally emptying its sprout produce; and

FIG. 17A to FIG. 17G are a series of schematic top views showing the shuttle slidingly horizontally pulling a seed germination tray thereon from the inbound conveyor and slidingly horizontal pushing it onto a seed germination tray shelf.

### DETAILED DESCRIPTION OF DRAWINGS

### Autonomous Hydroponic Seed Germination System

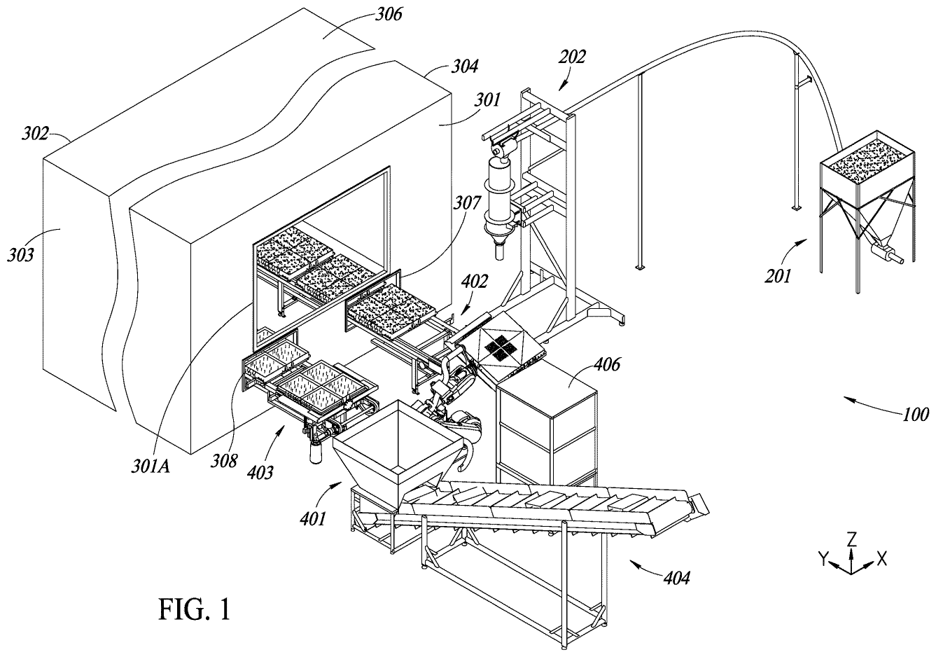

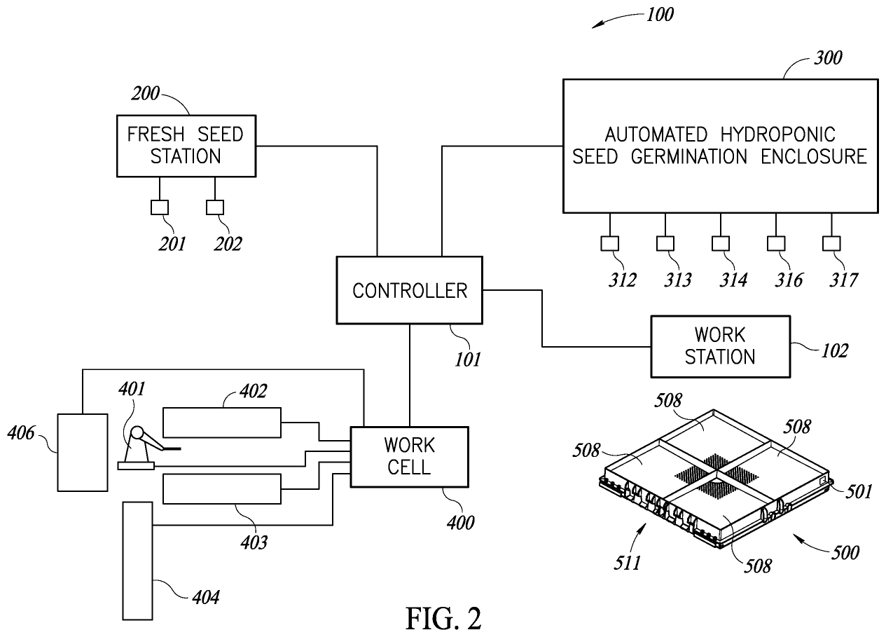

FIG. 1 and FIG. 2 show an Autonomous Hydroponic Seed Germination System (AHSGS) 100 for hydroponically germinating fresh seed to sprout produce and a Cartesian co-ordinate system X-axis, Y axis and Z-axis with the X-axis and the Y-axis defining a X-Y horizontal plane. The AHSGS 100 includes a controller 101 for controlling the following sub-systems: a fresh seed station 200, a climate-controlled Automated Hydroponic Seed Germination Enclosure (AHSGE) 300 and a work cell 400. The work cell 400 is typically housed in a closed environment for protection against prevailing weather conditions.

The AHSGS 100 includes a workstation 102 instructing the controller 101 for enabling an operator to set operating parameters for the AHSGS 100 and monitoring its operation. The workstation 102 is preferably in the form of a computerized Human Machine Interface (HMI). The workstation 102 is preferably operated by a touch screen. The workstation 102 can interface with a smartphone installed with a dedicated app for operating the AHSGS 100 and monitoring its operation.

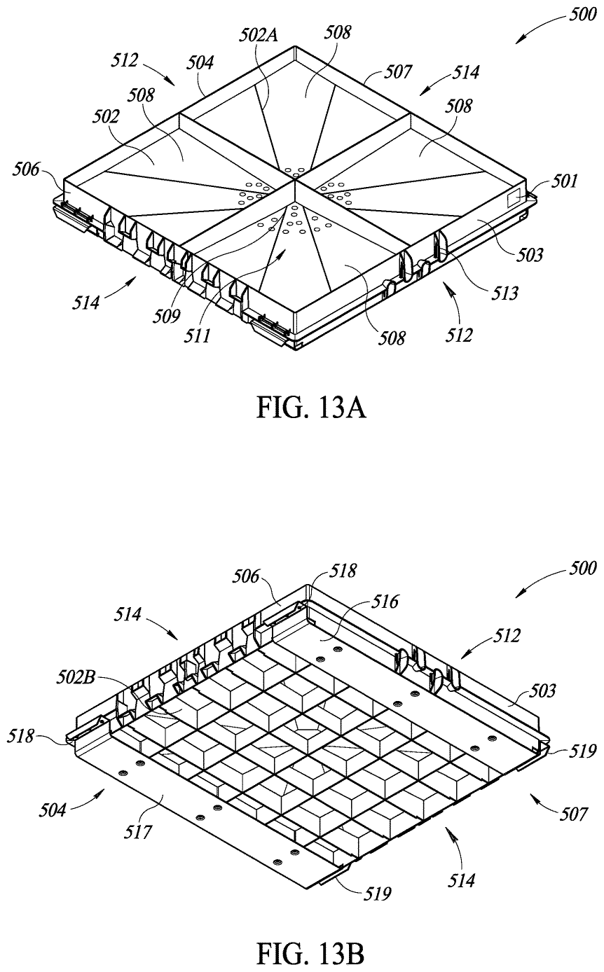

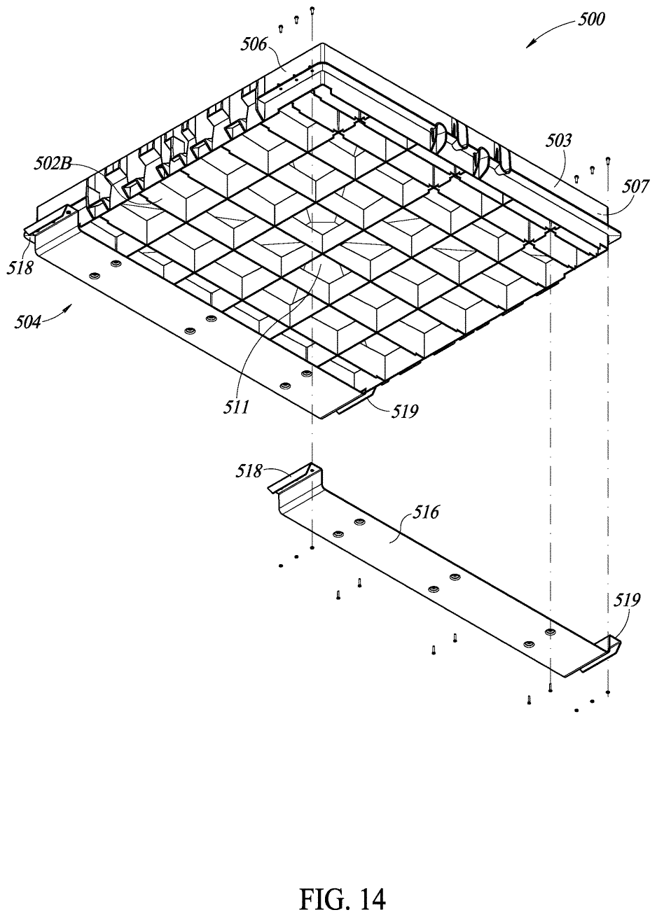

The AHSGS 100 employs seed germination trays 500 described hereinbelow with reference to FIG. 13 and FIG. 14 for hydroponically germinating fresh seed to sprout produce. Seed germination trays 500 are preferably 1 m by 1 m square and 10 cm deep. Seed germination trays 500 are preferably made from polypropylene or similar plastic material. Seed germination trays 500 preferably each have a unique tray identifier 501. Suitable tray identifiers 501 include inter alia a barcode, a QR code, and the like. Seed germination trays 500 include at least four seed germination tray sub-areas 508 for facilitating evenly spreading fresh seed thereover for germination purposes, and also subsequent removal of sprout produce for further processing. Seed germination trays 500 include a drainage arrangement 511 for draining excess irrigation water. The drainage arrangement 511 is optionally implemented by an array of throughgoing apertures in the form of bores, slits, and the like.

The fresh seed station 200 includes a seed silo 201, a fresh seed doser 202 for dosing fresh seed doses of predetermined weight, and a seed delivery pipe 203 connecting the seed silo 201 to the fresh seed doser 202.

The AHSGE 300 includes a front wall 301, a rear wall 302, opposite side walls 303 and 304 and a roof 306. The front wall 301 includes a front window 301A, and a spaced apart pair of front wall hatches 307 and 308. The front wall hatches 307 and 308 are fitted with cold room-like dividers for minimizing free passage of air between the AHSGE 300 and its exterior environment. The AHSGE 300 includes a leading seed germination tray handling chamber 309 and a trailing hydroponic seed germination chamber 311 correspondingly adjacent and remote the front wall 301. The leading seed germination tray handing chamber 309 is typically occupies a small portion of the AHSGE 300 compared to the trailing hydroponic seed germination chamber 311. The AHSGE 300 can optionally include a cold room-like divider between the leading seed germination tray handing chamber 309 and the trailing hydroponic seed germination chamber 311 for minimizing free air passage therebetween, thereby facilitating maintaining the trailing hydroponic seed germination chamber 311 at optimal climate conditions for seed germination.

The seed germination tray handling chamber 309 includes a seed imbibition station 312 for imbibing seeds for a pre-determined seed imbibition period. The hydroponic seed germination chamber 311 includes an illumination arrangement 313, an irrigation arrangement 314 and a drainage arrangement 316 for seed germination for a pre-determined seed germination period. The AHSGE 300 includes a shuttle 317 for travel between the seed germination tray handling chamber 309 and the hydroponic seed germination chamber 311.

The work cell 400 preferably includes a robot 401, a motorized inbound conveyor 402, a motorized outbound conveyor 403, a sprout produce station 404 and a washing station 406. The inbound conveyor 402 has an inbound conveyor start end 402A adjacent the robot 401 and an inbound conveyor finish end 402B inside the AHSGE 300. The outbound conveyor 403 has an outbound conveyor start end 403A inside the AHSGE 300 and an outbound conveyor finish end 403B adjacent the robot 401, the sprout produce station 404 and the washing station 406.

The robot 401 is employed for securely clamping a seed germination tray 500 under the fresh seed doser 202 for uniformly spreading seed thereon, placing the seed germination tray 500 on the inbound conveyor 402 for transportation to the AHSGE 300 for an initial pre-determined seed imbibition period and a subsequent pre-determined seed germination period, removing the seed germination tray 500 with sprout produce from the outbound conveyor 403 for transportation from the AHSGE 300, inverting the seed germination tray 500 for gravitationally emptying its sprout produce at the sprout produce station 404, and inserting the empty seed germination tray 500 into the washing station 406 for washing and disinfecting ready for re-use.

The AHSGS 100 can be readily scaled for providing a wide daily range of sprout produce. For example, the AHSGE 300 can be designed to provide 5 ton fodder biscuit for livestock consumption per day. Seed germination typically involves 5 times increase in weight such that 15 kg fresh seed germinates to 75 kg sprout produce over a 6 day seed germination period. 5 ton fodder biscuit production per day requires around 70 seed germination trays each with 75 kg sprout produce to be harvested each day: 75 kg×70 seed germination trays=5,250 kg sprout produce per day.

Assuming each seed germination tray rack has 7 shelves heightwise, the 70 seed germination trays occupy 5 shelves lengthwise along the spaced apart pair of parallel seed germination tray racks, namely, 7 shelves high×5 shelves long×2 seed germination tray racks=70 seed germination trays. Accordingly, for providing a daily 5 ton fodder biscuit production with a 6 day seed germination period, the seed germination tray racks are required to be 5 shelves long×6 day seed germination period=30 m long.

### Fresh Seed Station

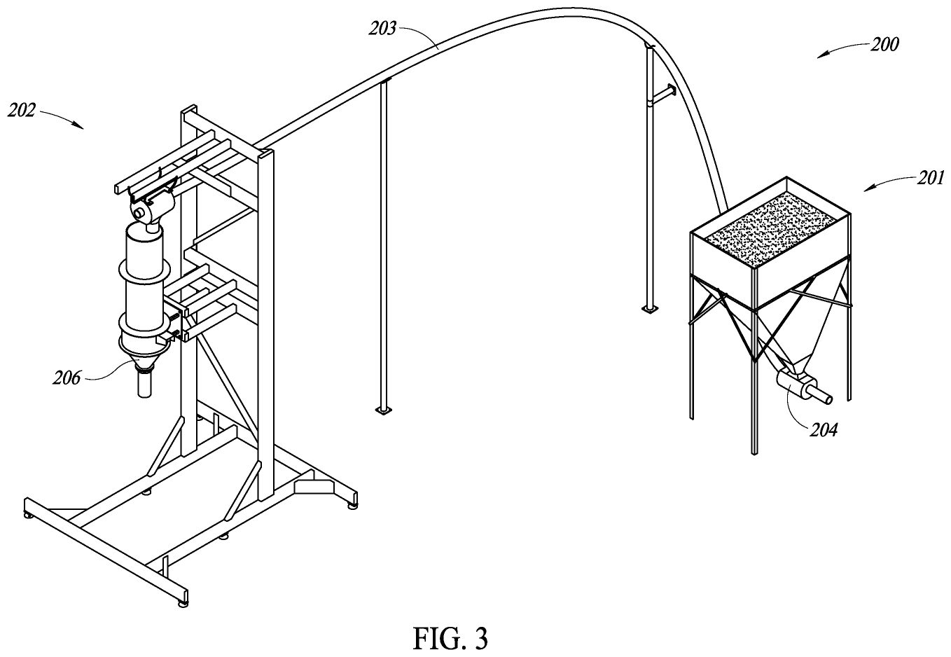

FIG. 3 shows a fresh seed station 200 in communication with the workstation 102 for dosing fresh seed doses of predetermined weight onto seed germination trays 500. The fresh seed station 200 includes a seed silo 201 containing loose seed, a fresh seed doser 202 for dosing fresh seed doses of predetermined weight, and a pipe 203 connecting the seed silo 201 and the fresh seed doser 202. The seed silo 201 includes an outlet valve 204, for example, an Exair Line Vac outlet valve employing the venturi effect for suctioning loose seed from the seed silo 201 to the fresh seed doser 202. The fresh seed doser 202 includes an outlet valve 206 for disposing fresh seed doses of pre-determined weight. The fresh seed doses typically have a mound-like appearance.

### Automated Hydroponic Seed Germination Enclosure

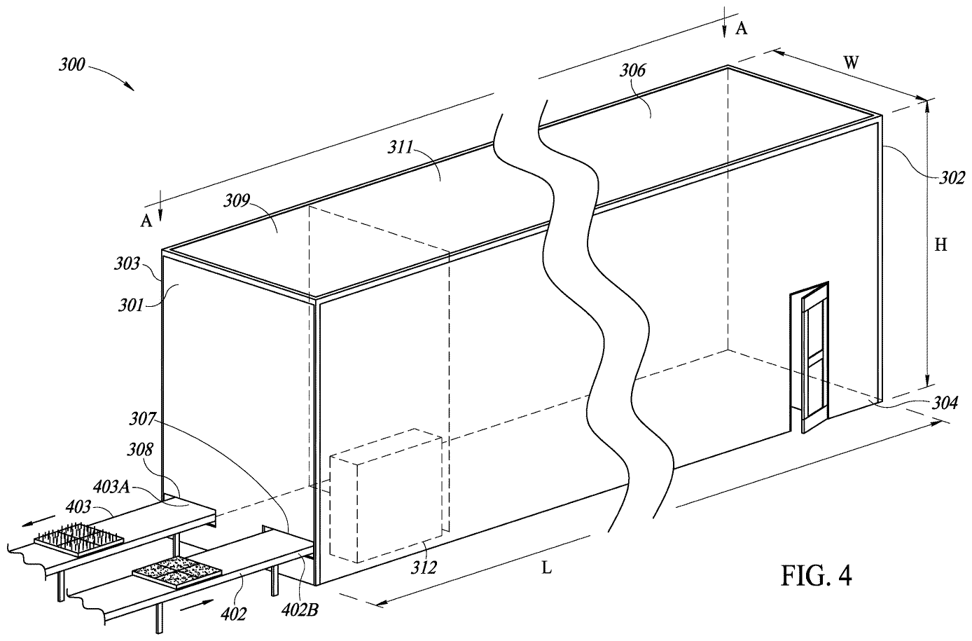

FIG. 4 shows the AHSGE 300 has external dimensions: length L, width W and height H. Typical dimensions for 5 ton fodder biscuit production per day are L=10 m, W=4 m and H 4 m. The inbound conveyor finish end 402B extends through the front wall hatch 307 into the seed germination tray handling chamber 309. The outbound conveyor start end 403A extends through the front wall hatch 308 into the seed germination tray handling chamber 309 opposite the inbound conveyor start end 402A. The shuttle 317 typically parks in the seed germination tray handling chamber 309.

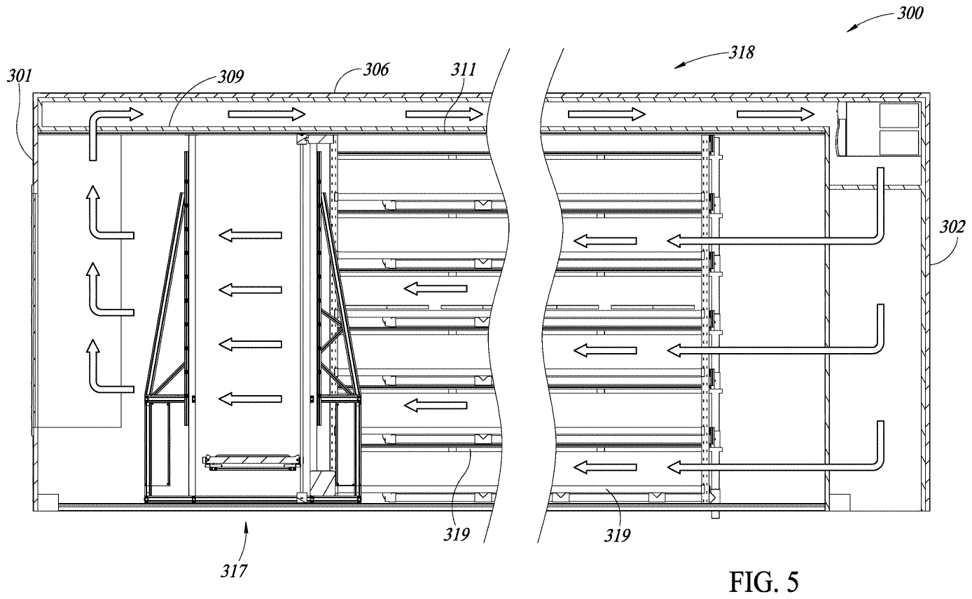

FIG. 5 shows the AHSGE 300 includes a double wall construction for maintaining a highly controlled climate for hydroponically germinating seed to sprout produce. The AHSGE 300 includes standard HVAC equipment for maintaining the following climate parameters: temperature from about 20° C. to about 25° C., humidity from about 65% to about 90%, CO₂ concentration from about 500 ppm to about 1,500 ppm, and wind speed therealong from about 0.5 msec⁻¹ to about 2 msec⁻¹.

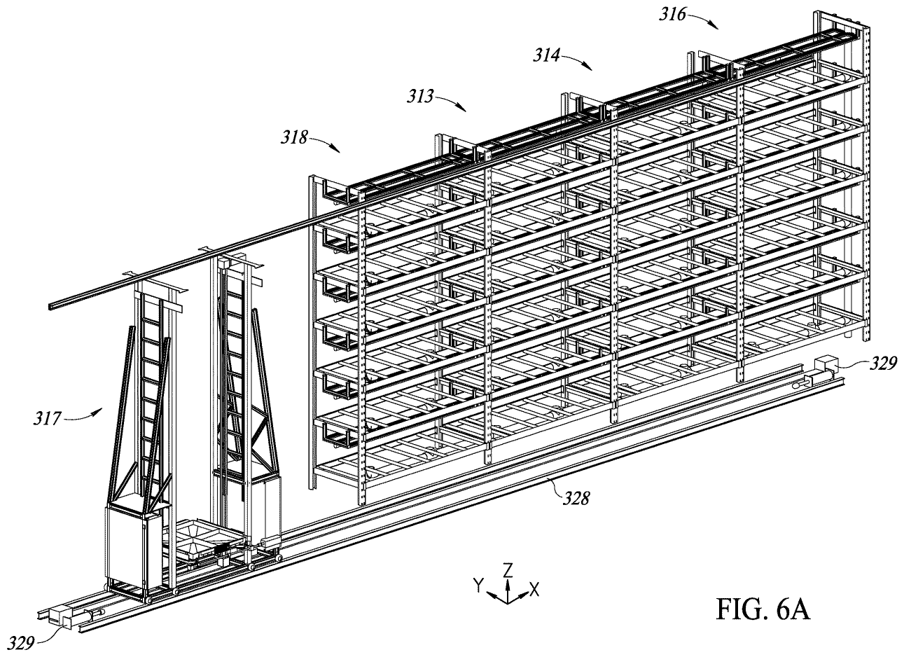

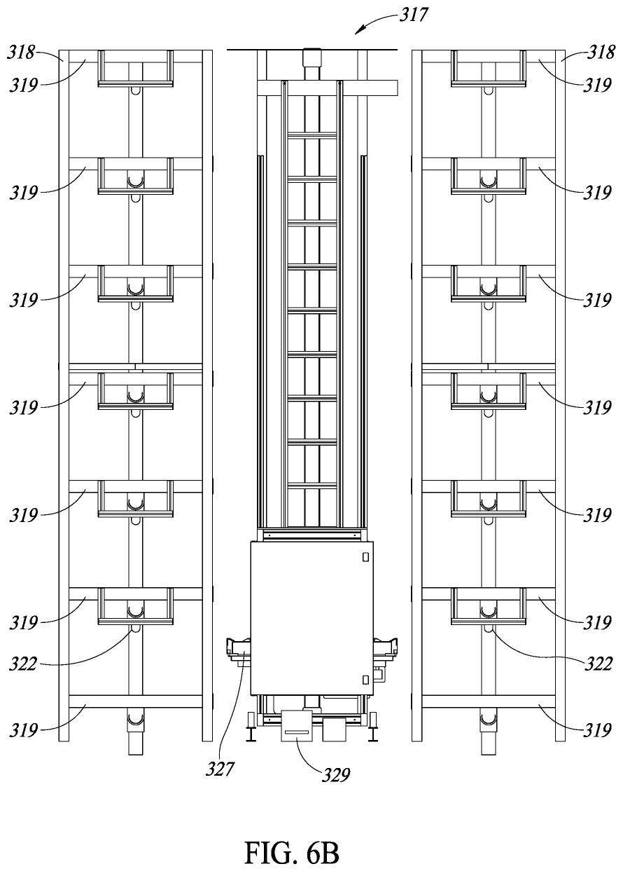

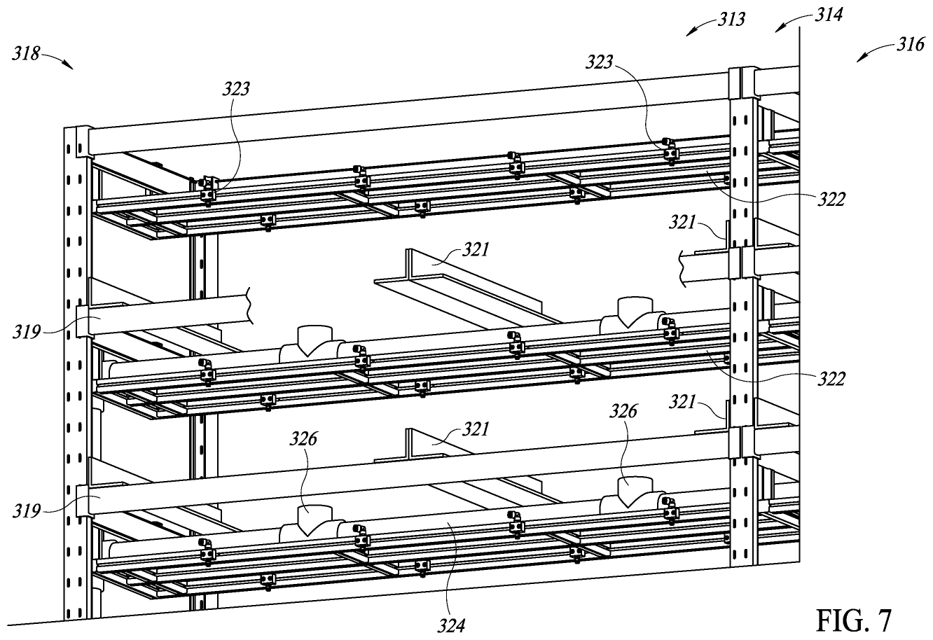

FIG. 6A, FIG. 6B and FIG. 7 show the seed germination chamber 311 includes a spaced apart pair of parallel seed germination tray racks 318. Each said seed germination tray rack 318 has seven seed germination tray shelves 319 heightwise. The seed germination tray shelves 319 are configured to hold eight seed germination trays 500 therealong. The seed germination tray shelves 319 have a spaced apart pair of parallel seed germination tray supports 321 for snugly receiving a seed germination tray 500 therebetween. The illumination arrangement 313 for illuminating the seed germination trays 500 is preferably in the form of elongated LEDs 322 extending along the length of the seed germination tray shelves 319. The irrigation arrangement 314 for irrigating the seed germination trays 500 is preferably in the form of spray devices 323 for spraying a mist on each seed germination tray quarter 508. The drainage arrangement 316 includes a drainage pipe 324 extending along the underside of each seed germination shelf 319 with drains 326 aligned in registration with the seed germination trays' drainage arrangements 511 for collecting excess irrigation therefrom.

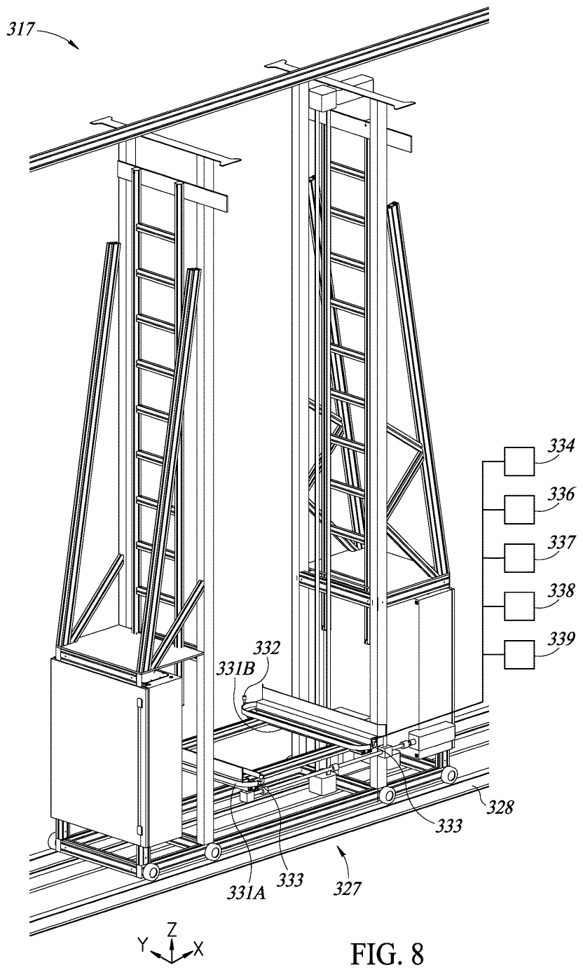

FIG. 8 shows the shuttle 317 includes a seed germination tray carriage 327 similarly sized and shaped as a seed germination tray 500 for bearing same. The shuttle 317 travels along a shuttle double rail 328 extending between the spaced apart pair of parallel seed germination tray racks 318 for displacement along the X-axis. The shuttle double rail 328 has shock absorbers 329 at its opposite ends for soft stopping of the seed germination tray carriage 327 thereat. The shuttle 317 enables displacement of the seed germination tray carriage 327 along the Z axis.

The seed germination tray carriage 327 includes a spaced apart pair of parallel belts 331, namely, a left belt 331A and a right belt 331B, each provided with an equispaced pair of displacement hooks 332 and 333 such that the spaced apart pair of parallel belts 331 have a first spaced apart pair of displacement hooks 332 for engaging a seed germination tray 500 in unison and a second spaced apart pair of displacement hooks 333 for engaging a seed germination tray 500 in unison. The belts 331 are driven in counterclockwise rotation to each other, namely, one belt 331 is driven clockwise and the other belt 331 is driven counterclockwise for sideways horizontal displacement of a seed germination tray 500 relative to the seed germination tray carriage 327 in the Y direction. The belts 331 are preferably step driven, namely, the belts 331 are driven only as required for sideways horizontally displacing a seed germination tray 500. The belts 331 can be rotated in both directions, namely, clockwise and counterclockwise depending on a relative location between the seed germination tray carriage 327 and a seed germination tray bearing surface, namely, the inbound conveyor 402, the outbound conveyor 403, and a seed germination tray shelf 319.

The seed germination tray carriage 327 includes one or more climate sensors for monitoring climate conditions at different locations in the hydroponic seed germination chamber 311 for enabling detection of malfunctions in the illumination arrangement 313 and the irrigation arrangement 314. Exemplary malfunctions include a burned LED, a blocked spray device, and the like. The climate sensors include one or more of: a humidity sensor 334, a temperature sensor 336, a CO₂ sensor 337 and an anemometer 338. The shuttle 317 optionally include a photometer 339 for monitoring light at different locations in the seed generating chamber 311.

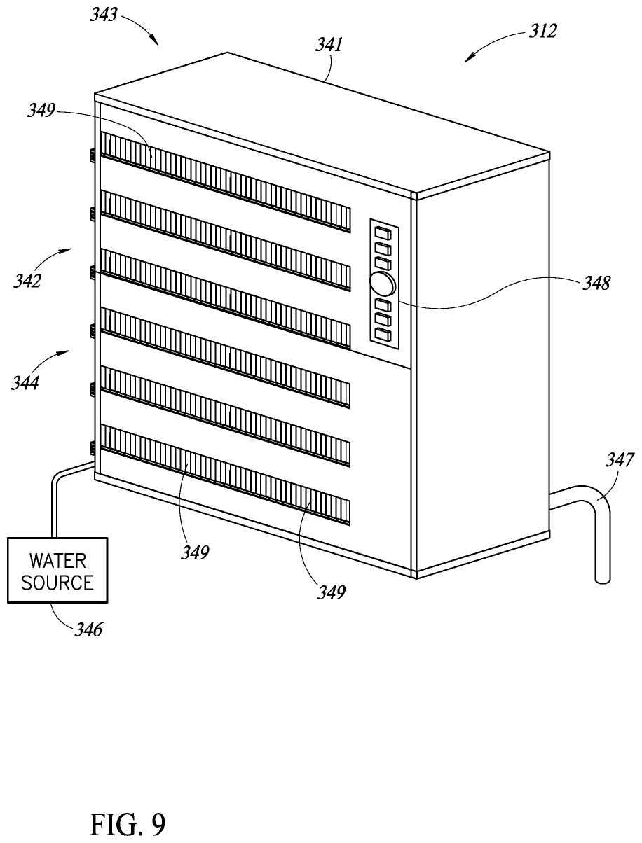

FIG. 9 shows the climate-controlled seed imbibition station 312 in communication with the workstation 102 for operating and monitoring purposes. The seed imbibition station 312 includes a seed imbibition station housing 341 having a seed imbibition station housing front surface 342 and accommodating a seed germination tray rack 343 for holding seed germination trays 500 for imbibing fresh seeds ready for transferring to the hydroponic seed germination chamber 311. The seed imbibition station housing front surface 342 has an aperture array 344 in registration with the seed germination tray rack 343. The seed imbibition station 312 is connected to a water source 346 for supplying water to spray devices (not shown) for creating a near 100% humid mist therein, and a drain 347 for drainage purposes. The seed imbibition station 312 optionally includes a control panel 348 for controlling its operation. The seed imbibition station housing 341 includes brush-like covers 349 similar to cold room dividers for covering the aperture array 344 for facilitating maintaining the near 100% humidity. The shuttle 317 places seed germination trays 500 on the seed germination tray rack 343 and removes them from the seed germination tray rack 343 in the same manner as on seed germination tray shelves 319.

### Work Cell

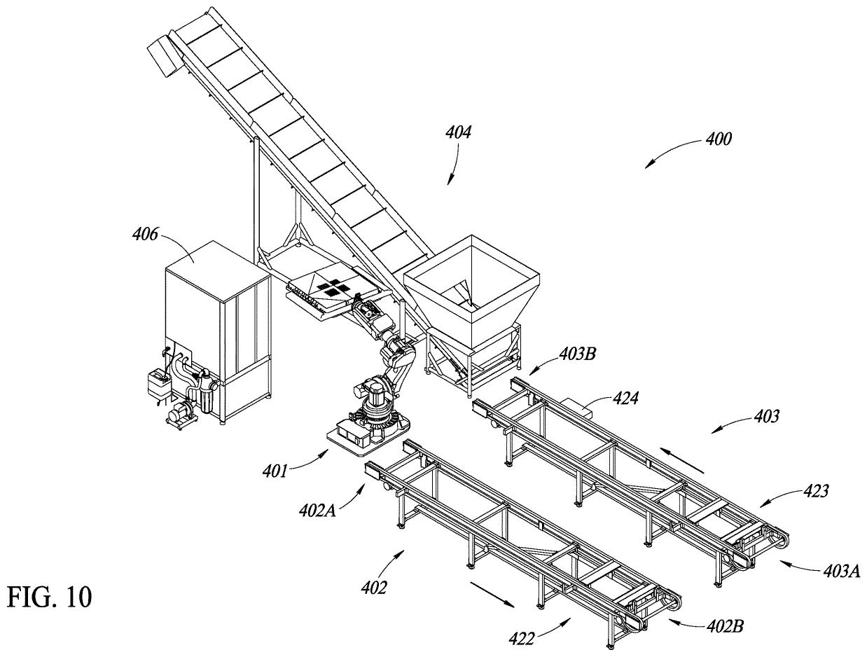

FIG. 10 shows the work cell 400 in communication with the workstation 102 for operating and monitoring purposes. The work cell 400 includes a robot 401, an inbound conveyor 402, an outbound conveyor 403, a sprout produce station 404 and a washing station 406 for washing and disinfecting seed germination trays 500 ready for re-use. The inbound conveyor 402 and the outbound conveyor 403 optionally include sensors for detecting the presence of a seed germination tray 500 for intermittent operation. Alternatively, the inbound conveyor 402 and the outbound conveyor 403 can be continuously operated.

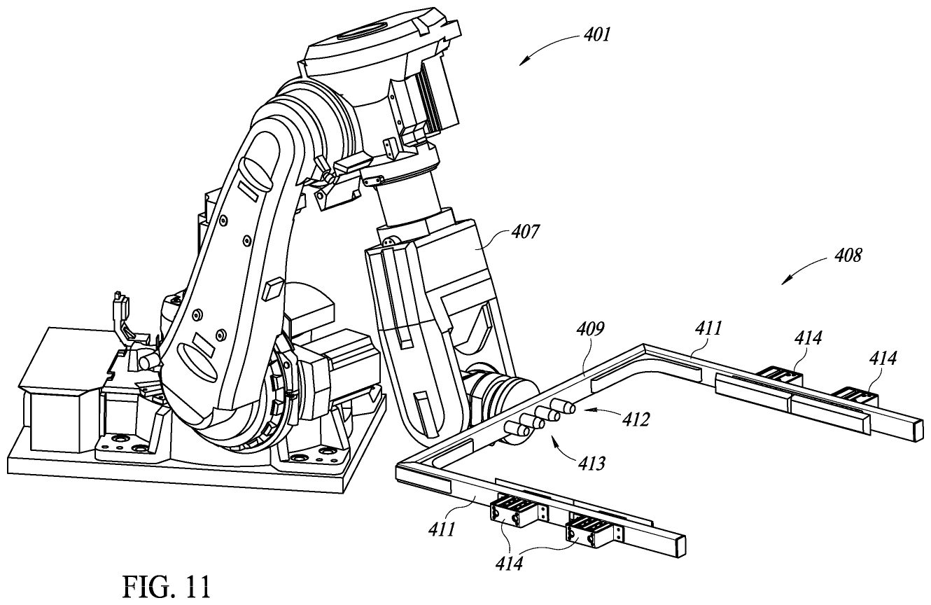

FIG. 11 shows the robot 401 is preferably a commercially available robot, for example, ABB IRB6620 having a maximum payload of 150 kg and 2200 mm reach. The robot 401 is firmly anchored on a support surface, namely, the robot 401 is stationary in the X-Y horizontal plane. Such firm anchoring is required such that the robot 401 is capable of supporting 150 kg×2.2 m reach=3.3 kNm. The robot 401 includes an articulated arm 407 terminating in a square U shaped 3 point gripper 408 for securely clamping a seed germination tray 500 for manipulation and transportation purposes. The articulated arm 407 is capable of being rotated through 360° for inverting a seed germination tray 500 for gravitationally emptying its sprout produce at the sprout produce station 404. The square U shaped 3 point gripper 408 includes a crossbeam 409 and a pair of opposite side arms 411. The crossbeam 409 has a central engagement component 412. The central engagement component 412 is preferably constituted by a pin array 413. The side arms 411 each have a pair of pneumatic piston grips 414 therealong.

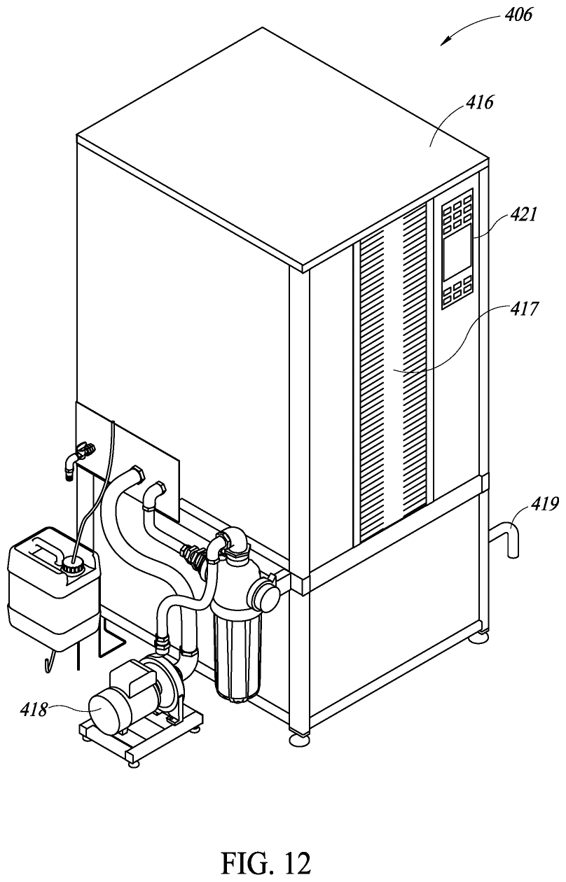

FIG. 12 shows the washing station 406 in communication with the workstation 102 for operating and monitoring purposes. The washing station 406 includes a washing station housing 416 having an upright slot 417 for enabling the robot 401 to insert a seed germination tray 500 thereinto and remove it therefrom. The washing station 406 is connected to a water source 418 for supplying water and disinfectant to spray devices (not shown) and a drain 419 for drainage purposes. The washing station 406 can optionally include a control panel 421 for controlling its operation. The washing station 406 can optionally include a hot air device (not shown) for blowing hot air to blow dry a seed germination tray 500.

Reverting to FIG. 10, the inbound conveyor finish end 402B can optionally include an inbound conveyor elevator 422 for elevating a seed germination tray 500 with fresh seed from the inbound conveyor 402 for assisting its transfer onto the seed germination tray carriage 327. Similarly, the outbound conveyor start end 403A can optionally include an outbound conveyor elevator 423 for elevating a seed germination tray 500 assisting its transfer from the seed germination tray carriage 327 onto the outbound conveyor start end 403A. The outbound conveyor elevator 423 is raised such that a seed germination tray 500 can be pushed thereon from the seed germination tray carriage 327 and then it is lowered such that the seed germination tray 500 is disposed on the outbound conveyor start end 403A.

The outbound conveyor 403 can optionally include a load cell weighing machine 424 for weighing sprout produce of seed germination trays 500 for monitoring purposes. The load cell weighing machine 424 preferably records the weight of sprout produce of each seed germination tray 500 at the workstation 102.

### Seed Germination Tray

FIG. 13A, FIG. 13B and FIG. 14 show the seed germination tray 500 configured for being securely clamping by the robot's 3 point gripper 408 and slidingly horizontal displaceable by the shuttle 317 for manipulation purposes. The seed germination tray 500 has a unique tray identifier 501. The seed germination tray 500 includes a 1 m square base 502, a first pair of opposite side walls 503 and 504 and a second pair of opposite side walls 506 and 507 transverse to the first pair of opposite side walls 503 and 504. The base 502 has a base top surface 502A and a base bottom surface 502B. The seed germination tray 500 is made from suitable plastic material, for example, polypropylene. The base top surface 502A is divided into four seed germination tray quarters 508. The base 502 has an inverted pyramid shape converging to a lowermost center 509 formed with a drainage arrangement 511 for draining excess irrigation water from the four seed germination tray quarters 508. The drainage arrangement 511 is optionally configured as an array of throughgoing apertures in the form of bores, slits, and the like.

For repeated detachable engagement by the 3 point gripper 408, the side walls 503 and 504 each have a central engagement component 512 complementary to the 3 point gripper 408's central engagement component 412 for enabling their engagement for centering the seed germination tray 500 relative to the articulated arm 407. Accordingly, the central engagement component 512 is constituted by a recess array 513 for receiving the pin array 413. Providing both side walls 503 and 504 with the same central engagement component 512 enables a seed germination tray 500 to be indexable relative to a robot's 3 point gripper 408. The side walls 506 and 507 each have a piston grip depression arrangement 514 configured for sliding insertion of the pneumatic piston grips 414 thereinto thereby enabling a seed germination tray 500 to be securely clamped by a robot's 3 point gripper 408 in both an upright position and an inverted position. The pneumatic piston grips 414 are slidingly withdrawn from the piston grip depression arrangements 514 for releasing a seed germination tray 500 from a robot's 3 point gripper 408.

For repeated detachable engagement by the shuttle 317, the seed germination tray 500 is configured for being engaged by the spaced apart pairs of displacement hooks 332 and 333. The seed germination tray 500 includes a pair of spaced apart elongated plates 516 and 517 attached to the base bottom surface 502B correspondingly adjacent the side walls 503 and 504 and lateral to the piston grip depression arrangements 514. The elongated plate 516 and the elongated plate 517 include a spaced apart pair of inverted L-shaped projections 518 projecting beyond the side wall 506. The elongated plate and the elongated plate 517 include a spaced apart pair of inverted L-shaped projections 519 projecting beyond the side wall 507.

Such seed germination trays 500 can be readily placed by the robot 401 on the inbound conveyor 402 and the outbound conveyor 403 with their side walls 506 and 507 co-directional with the inbound conveyor 402 and the outbound conveyor 403 whereby the seed germination trays 500 can be readily engaged by the shuttle 317.

Alternatively, the pair of spaced apart elongated plates 516 and 517 can be attached to the base bottom surface 502B correspondingly adjacent the side walls 506 and 507 such that their spaced apart pairs of inverted L-shaped projections 518 and 519 project beyond the side walls 506 and 507.

### Robot Operation

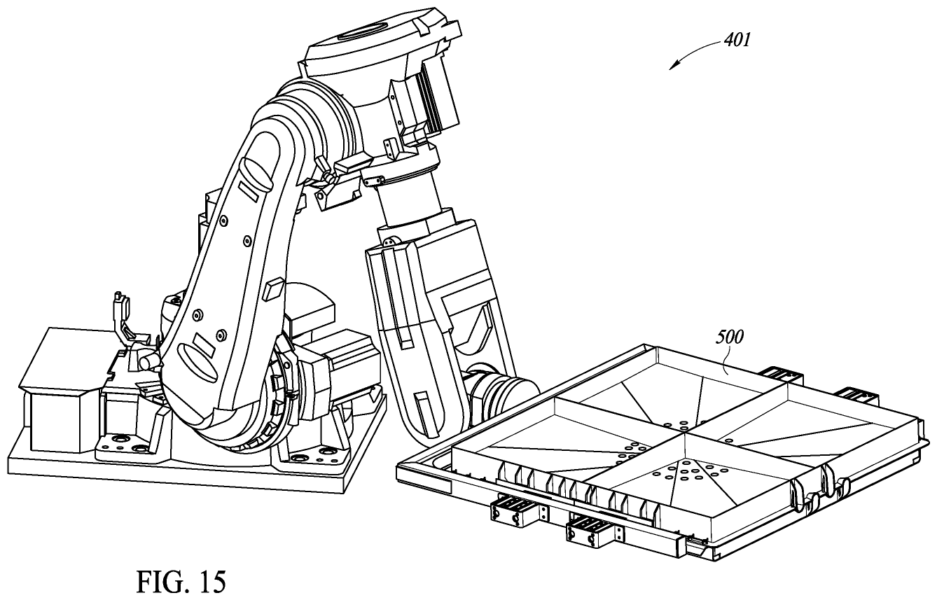

FIG. 15 shows the robot 401 securely clamping the seed germination tray 500 by virtue of its pin array 413 having been initially inserted into the seed germination tray's recess array 513 and subsequently its pneumatic piston grips 414 being inserted into the seed germination tray's piston grip depression arrangements 514.

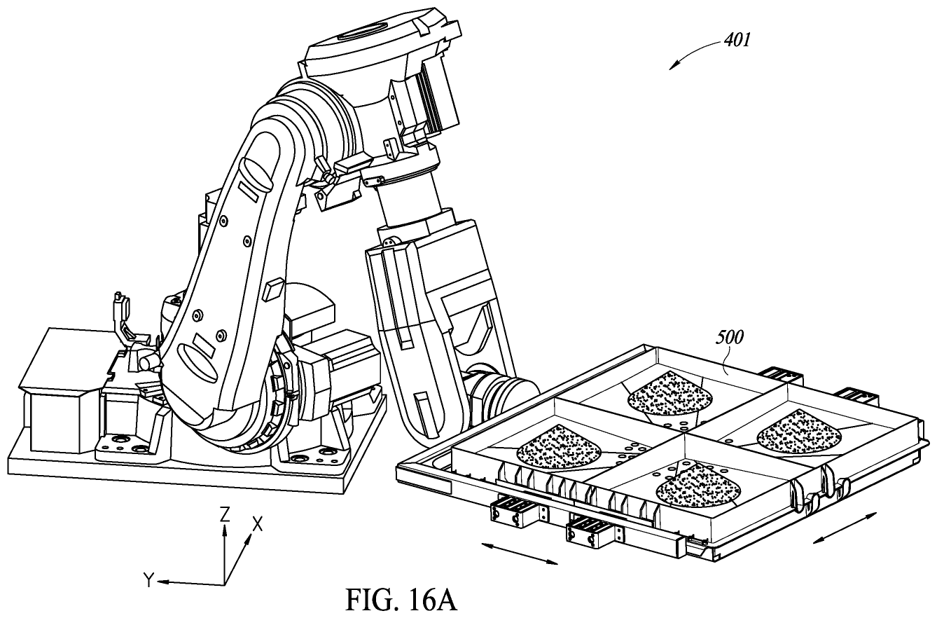

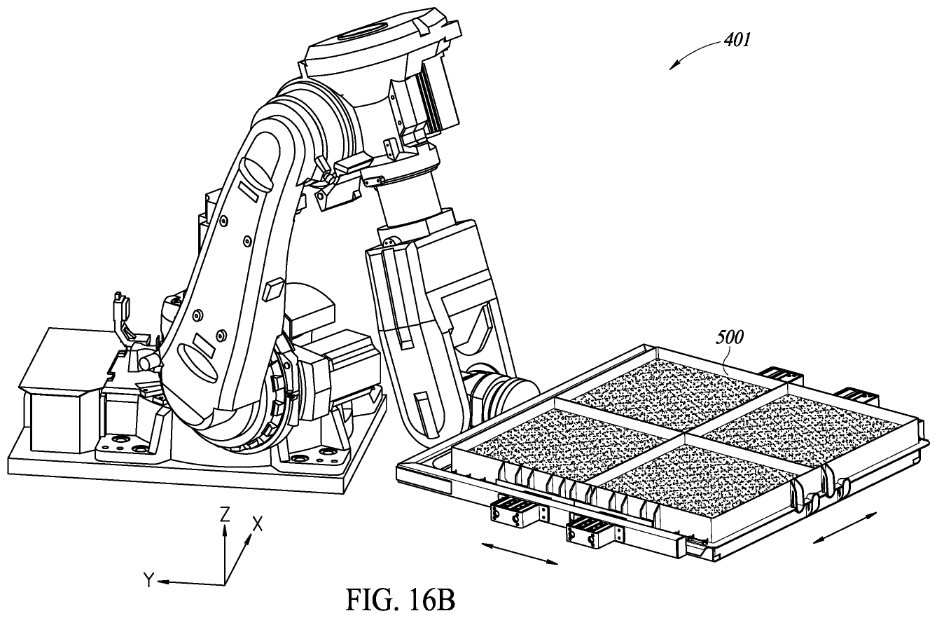

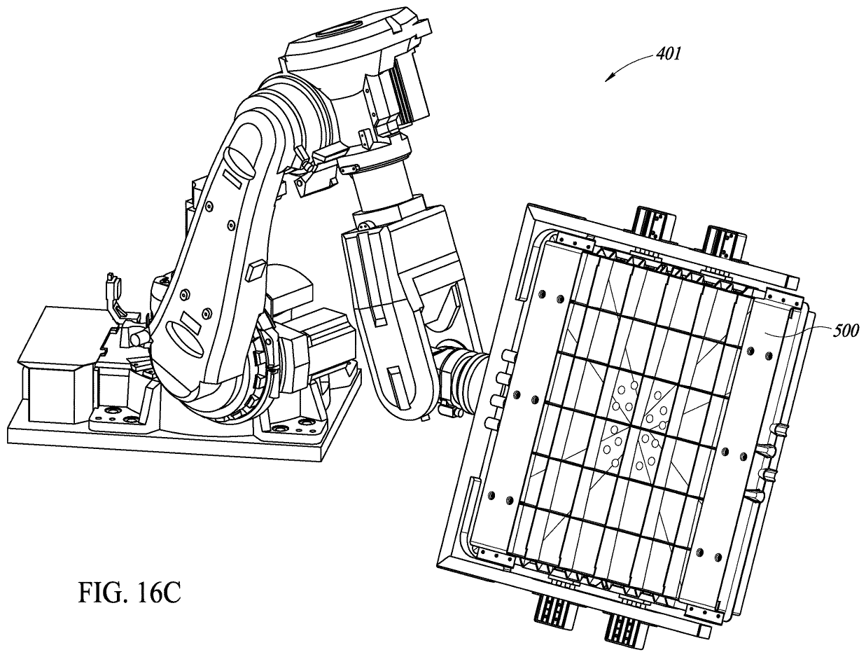

FIG. 16A and FIG. 16B show operation of the robot 401 for preparing a seed germination tray 500 with fresh seed ready for transfer to the AHSGE 300. The robot 300 holds securely clamps a seed germination tray 500 and disposes it under the fresh seed doser 200 for dosing four fresh seed doses correspondingly on its four seed germination tray quarters 508 (see FIG. 16A). The robot 300 repeatedly and rapidly agitates the seed germination tray 500 in the X-Y horizontal plane for flattening the fresh seed doses for evenly spreading the fresh seed over the four seed germination tray quarters 508 (see FIG. 16B).

FIG. 16C shows the articulated arm 407 is capable of being rotated through 360° for inverting a seed germination tray 500 for gravitationally emptying its sprout produce at the sprout produce station 404.

The robot 300 holds continuously securely clamps a seed germination tray 500 for executing the following steps:
a) lifting the seed germination tray 500 from the outbound conveyor 403 at the outbound conveyor finish end 403B
b) inverting the seed germination tray 500 for gravitationally emptying its sprout produce at the sprout produce station 404
c) inserting the empty seed germination tray 500 into the washing station 406 for being washed and disinfected
d) removing the seed germination tray 500 from the washing station 406
e) holding the seed germination tray 500 under the fresh seed doser 202 for dosing a fresh seed dose(s) thereon
f) repeatedly and rapidly agitating the seed germination tray 500 in the X-Y horizontal plane for flattening the fresh seed dose(s) for evenly spreading fresh seed and
g) placing the seed germination tray with fresh seed on the inbound conveyor 402 at the inbound conveyor start end 402A for transfer to the AHSGE 300

### Shuttle Operation

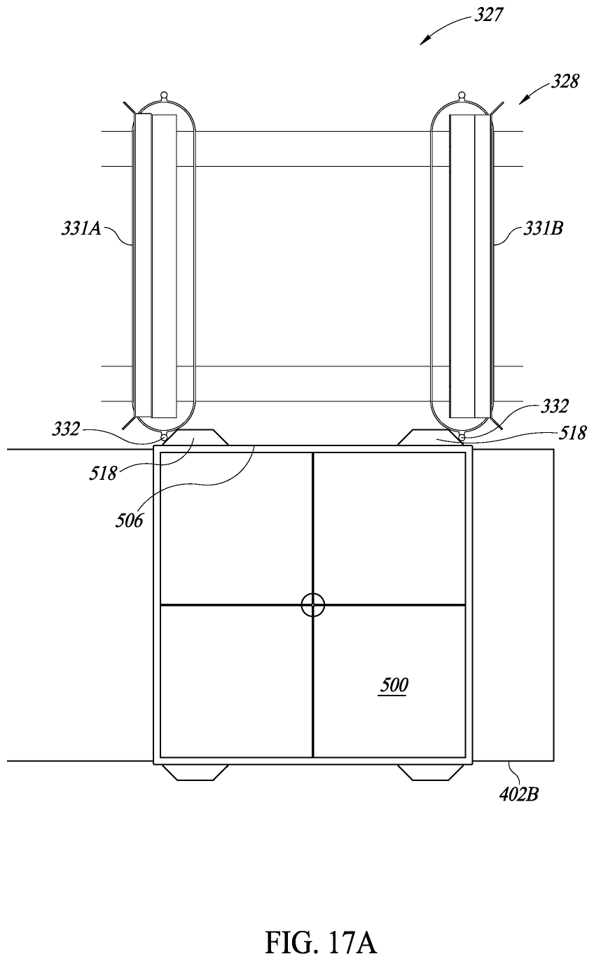

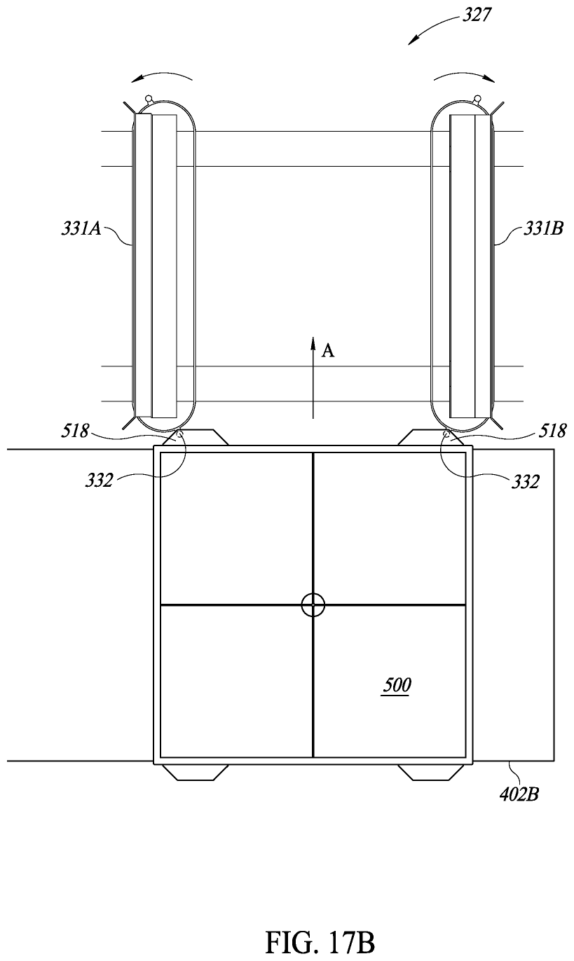

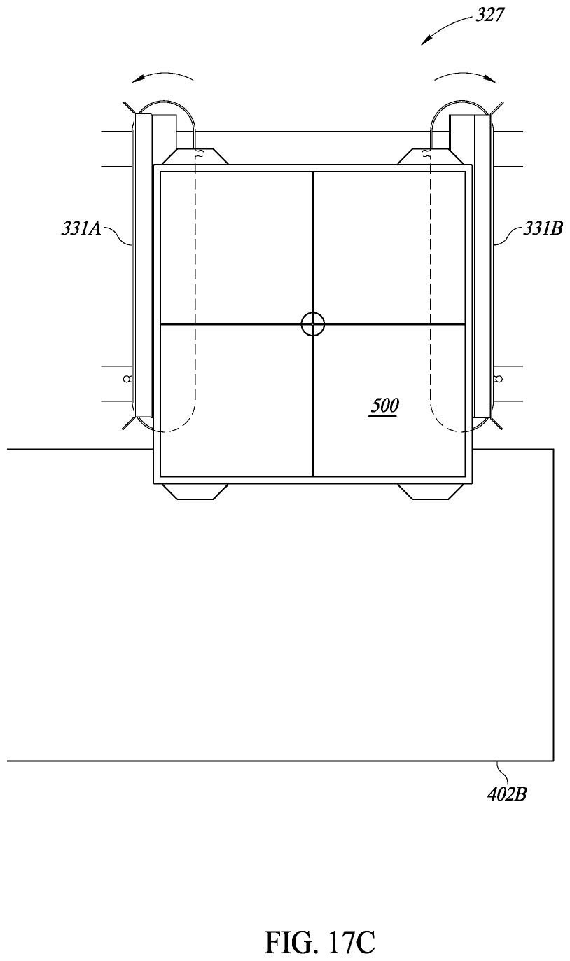

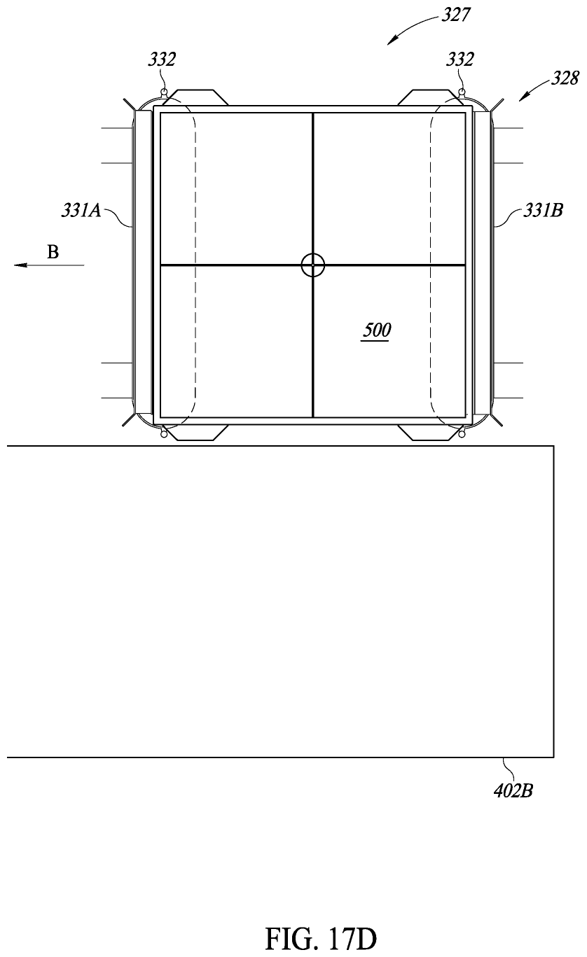

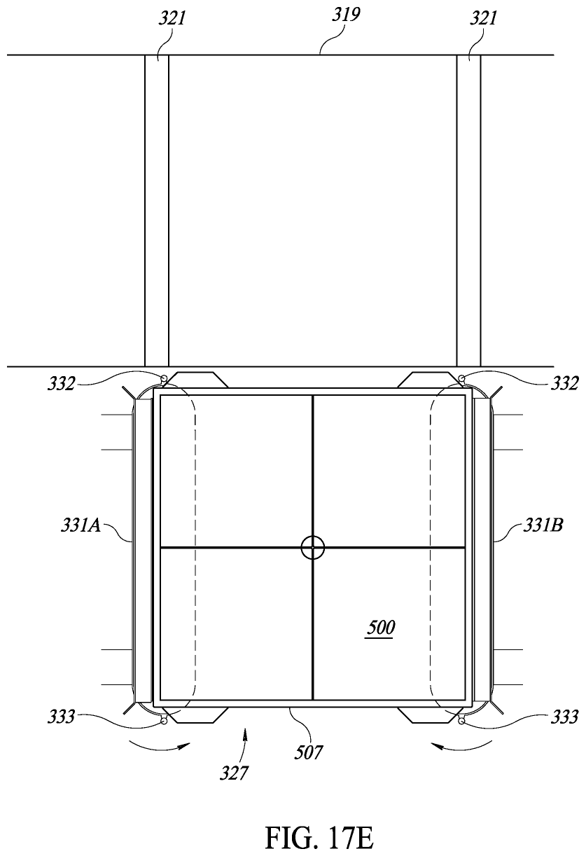

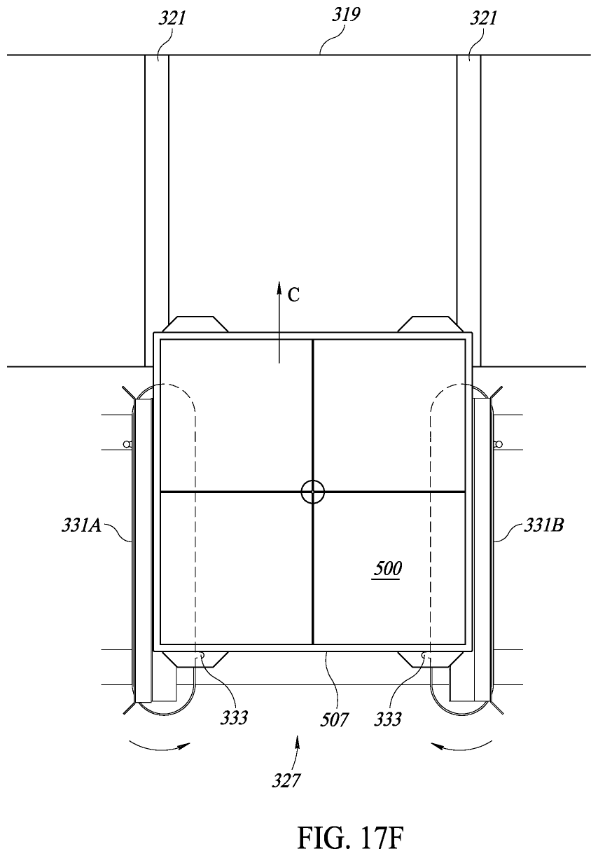

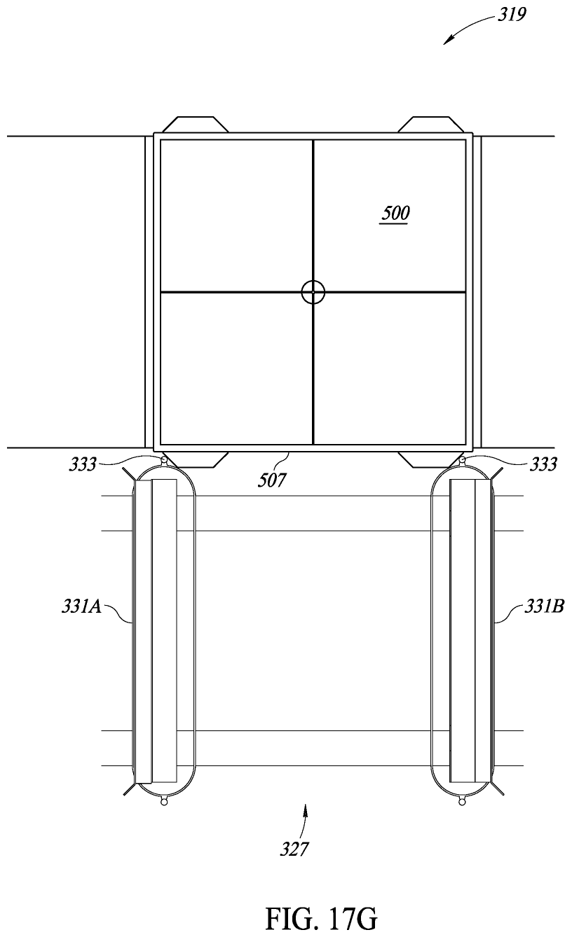

FIG. 17A to FIG. 17G show operation of the seed germination tray carriage 327 for initially slidingly horizontally pulling a seed germination tray 500 with fresh seed thereon from the inbound conveyor finish end 402B and subsequently slidingly horizontally pushing the seed germination tray 500 on a seed germination tray shelf 319 for seed germination to sprout produce. Sideways horizontally pulling a seed germination tray 500 with sprout produce from a seed germination tray shelve 319 onto the seed germination tray carriage 327 and sideways horizontally pushing a seed germination tray 500 from the seed germination tray carriage 327 onto the outbound conveyor start end 403A is the reverse of the FIG. 17A to FIG. 17G operation. Depending on the relative positions of the seed germination tray 500 and the seed germination tray carriage 327, the seed germination tray 500 conceals parts of the belts 331A and 331B, the displacement hooks 332 and the displacement hooks 333 as shown in dashed lines.

FIG. 17A to FIG. 17G operation is as follows:

FIG. 17A shows the seed germination tray carriage 327 at its parking position juxtaposed to the inbound conveyor finish end 402B. The belts 331 are stationary. The displacement hooks 332 are at their initial non-engaging position. A seed germination tray 500 lies on the inbound conveyor finish end 402B with its spaced apart pair of inverted L-shaped projections 518 adjacent the seed germination tray carriage 327.

FIG. 17B shows the left belt 331A starts to rotate in a counterclockwise direction and the right belt 331B starts to rotate in a clockwise direction. The displacement hooks 332 engage the inverted L-shaped projections 518 for sideways horizontal pulling the seed germination tray 500 onto the seed germination tray carriage 327 as denoted by arrow A.

FIG. 17C shows the left belt 331A's continuing counterclockwise rotation and the right belt 331B's continuing clockwise rotation for further sideways horizontal pulling the seed germination tray 500 onto the seed germination tray carriage 327.

FIG. 17D shows the left belt 331A's displacement hook 332 and the right belt 331B's displacement hook 332 are rotated outwardly beyond their respective inverted L-shaped projections 518 after the seed germination tray 500 is fully placed on the seed germination tray carriage 327. The belts 331 are stationary. The seed germination tray carriage 327 can now be moved along the shuttle double rail 328 as denoted by arrow B and raised to an intended seed germination tray shelf 319.

FIG. 17E shows the seed germination tray carriage 327 bearing the seed germination tray 500 juxtaposed to a seed germination tray shelf 319 ready for being slidingly horizontally pushed onto a spaced apart pair of parallel seed germination tray supports 321. The belts 331 are stationary. The left belt 331A is ready to be driven in a counter clockwise direction and the right belt 331B is ready to be driven in a clockwise direction.

FIG. 17F shows the left belt 331A's counterclockwise rotation and the right belt 331B's clockwise rotation for sideways horizontally pushing the seed germination tray 500 from the seed germination tray carriage 327 onto the seed germination tray shelf 319 as denoted by arrow C by means of the spaced apart pair of displacement hooks 333 urging against the side wall 507.

FIG. 17G shows the left belt 331A's displacement hook 333 and the right belt 331B's displacement hook 333 are rotated outwardly beyond the side wall 507 after the seed germination tray 500 is fully pushed from the seed germination tray carriage 327 onto the seed germination tray shelf 319.

The belts 331 with spaced apart pair of displacement hooks 332 only, namely, without the spaced apart pair of displacement hooks 333, can perform the same FIG. 17A to FIG. 17G operation but would require additional driving of the belts 331 such that the spaced apart pair of displacement hooks 332 act in place of the spaced apart pair of displacement hooks 333.

### AHSGS Operation

The controller instructs the robot to securely clamp an empty seed germination tray under the fresh seed doser. The fresh seed doser doses four fresh seed doses on the seed germination tray quarters.

The controller instructs the robot to repeatedly and rapidly agitate the seed germination tray in the X-Y horizontal plane for flattening the fresh seed doses to evenly spread the fresh seed over their corresponding four seed germination tray quarters.

The controller instructs the robot to place the seed germination tray with fresh seed on the inbound conveyor start end and drives the inbound conveyor to transport the seed germination tray into the leading seed germination tray handling chamber whereupon the controller stops the inbound conveyor.

The controller raises the inbound conveyor elevator to raise the seed germination tray with fresh seed and instructs the shuttle to remove the seed germination tray from the inbound conveyor elevator.

The controller instructs the shuttle to push the seed germination tray with fresh seed on a designated seed germination tray shelve in the seed imbibition station for imbibing the seeds.

The controller instructs the shuttle to pull the seed germination tray from the seed imbibition station and push it on a designated seed germination tray shelve in the hydroponic seed germination chamber for a predetermined seed germination period to form sprout produce.

At the end of the seed germination period, the controller instructs the shuttle to retrieve the seed germination tray with its sprout produce from the seed germination tray shelf.

The controller raises the outbound conveyor elevator and instructs the shuttle to push the seed germination tray with sprout produce thereon.

The controller lowers the outbound conveyor elevator such that the seed germination tray with sprout produce is disposed on the outbound conveyor start end.

The controller drives the outbound conveyor to transport the seed germination tray to the sprout produce station.

The controller stops the outbound conveyor and instructs the robot to securely clamp the seed germination tray and invert it to gravitationally empty its sprout produce at the sprout produce station.

The controller instructs the robot to insert the now empty seed germination tray into the washing station for washing and disinfecting ready for re-use.

While the invention has been described with respect to a limited number of embodiments, it will be appreciated that many variations, modifications, and other applications of the invention can be made within the scope of the appended claims.

1.-20. (canceled)

21. An autonomous hydroponic seed germination system for hydroponically germinating seed in seed germination trays to sprout produce, the autonomous hydroponic seed germination system comprising:
(a) a climate-controlled automated hydroponic seed germination enclosure including:
i) a hydroponic seed germination chamber having at least one spaced apart pair of parallel seed germination tray racks, each said seed germination tray rack having at least four seed germination tray shelves heightwise and configured for receiving a multitude of seed germination trays therealong, and
ii) at least one shuttle slidingly displaceable along a shuttle rail between said at least one spaced apart pair of parallel seed germination tray racks for initially placing seed germination trays with fresh seed on said at least one spaced apart pair of parallel seed germination tray racks and, after a predetermined seed germination period for hydroponically germinating seed to sprout produce, subsequently removing seed germination trays from said at least one spaced apart pair of parallel seed germination tray racks;
(b) a work cell including at least one robot stationary in a X-Y horizontal plane, a robot of said at least one robot including an articulated arm for securely clamping a seed germination tray;
(c) a seed germination tray buffer between said climate-controlled automated hydroponic seed germination enclosure and said work cell,
said seed germination tray buffer including a weighing device for weighing a seed germination tray with sprout produce;
(d) a fresh seed station including a fresh seed doser for dosing fresh seed doses of a predetermined weight on a seed germination tray;
(e) a sprout produce station for handling sprout produce;
(f) a washing station for washing and disinfecting an empty seed germination tray; and
(g) a workstation for enabling an operator to set operating parameters for the autonomous hydroponic seed germination system and monitor its operation,
said workstation including a controller simultaneously controlling at least said automated hydroponic seed germination enclosure, said work cell, and said fresh seed station, said workstation in communication with said weighing device,
the operation of the autonomous hydroponic seed germination system including the following steps:
step a) at said seed germination tray buffer, weighing the seed germination tray with sprout produce, and
step b) a said robot continuously securely clamping a seed germination tray with sprout produce at said seed germination tray buffer and executing the following steps:
step i) lifting the seed germination tray with sprout produce in an upright position from said seed germination tray buffer,
step ii) at said sprout produce station, inverting the seed germination tray to an inverted position to gravitationally empty its sprout produce,
step iii) inserting the empty seed germination tray into said washing station, step iv) removing the empty seed germination tray from said washing station,
step v) at said fresh seed station, holding said seed germination tray under said fresh seed doser for dosing at least one fresh seed dose thereon,
step vi) repeatedly and rapidly agitating the seed germination tray in the X-Y horizontal plane for flattening the at least one fresh seed dose evenly over the seed germination tray, and
step vii) placing the seed germination tray with at least one evenly flattened fresh seed dose on said seed germination tray buffer for subsequent germination in said climate-controlled automated hydroponic seed germination enclosure.

22. The system according to claim 21 wherein said seed germination tray buffer is under the control of said controller and is constituted by at least one motorized conveyor,
at said step i), a said robot lifts the seed germination tray from a said motorized conveyor, and
at said step vii), a said robot places the seed germination tray on a said motorized conveyor.

23. The system according to claim 21 wherein said climate-controlled automated hydroponic seed germination enclosure additionally includes a seed germination tray handling chamber between said seed germination tray buffer and said hydroponic seed germination chamber, and
a cold-room like divider between said seed germination tray handling chamber and said hydroponic seed germination chamber.

24. The system according to claim 21 wherein a said robot includes a square U-shaped gripper having a crossbeam and a pair of opposite side arms, said crossbeam having a central engagement component and said pair of opposite side arms each having at least one grip therealong,
a seed germination tray includes a generally rectangular base having a drainage arrangement for enabling excess irrigation to drain from the seed germination tray,
a first pair of opposite side walls having a central engagement component along at least one side wall of its first pair of opposite side walls, the central engagement component complementary to said crossbeam's central engagement component, and
a second pair of opposite side walls transverse to its first pair of side walls having an opposite pair of piston grip depression arrangements configured for sliding insertion of said pneumatic piston grips thereinto,
the arrangement beings such that said U-shaped gripper continually securely clamps the seed germination tray in said upright position and said inverted position by initial insertion of said crossbeam's central engagement component into the seed germination tray's central engagement component and subsequent insertion of said pneumatic piston grips into the seed germination tray's opposite pair of piston grip depression arrangements.

25. The system according to claim 24 wherein a said shuttle includes a spaced apart pair of parallel belts having at least one spaced apart pair of displacement hooks,
the seed germination tray including a pair of opposite side walls having a spaced apart pair of inverted L-shaped projections configured for being selectively engaged by said at least one spaced apart pair of displacement hooks for slidingly horizontally displacing the seed germination tray.

26. A seed germination tray for hydroponically germinating seeds to sprout produce, the seed germination tray configured for use with a robot and a shuttle,
the robot including a square U-shaped gripper for securely clamping the seed germination tray, the square U-shaped gripper having a crossbeam and a pair of opposite side arms, and the pair of opposite side arms each having at least one grip therealong,
a shuttle including a spaced apart pair of parallel belts having at least one spaced apart pair of displacement hooks,
the seed germination tray comprising:
(a) a generally rectangular base having a drainage arrangement for enabling excess irrigation to drain from the seed germination tray;
(b) a first pair of opposite side walls;
(c) a second pair of opposite side walls transverse to said first pair of side walls;
(d) a pair of opposite side walls of said first pair of opposite side walls and said second pair of opposite side walls, said pair of opposite side walls having an opposite pair of piston grip depression arrangements configured for being removably securely clamped by the square U-shaped gripper, whereby the U-shaped gripper is capable of securely clamping the seed germination tray in an upright position and an inverted position; and
(e) a pair of opposite side walls of said first pair of opposite side walls and said second pair of opposite side walls, said pair of opposite side walls having a spaced apart pair of inverted L-shaped projections configured for being selectively engaged by the at least one spaced apart pair of displacement hooks for slidingly horizontally displacing the seed germination tray.

27. The tray according to claim 26 wherein the central engagement component includes a pin array and said central engagement component is constituted by a recess array for receiving the pin array.

28. The tray according to claim 26 wherein said base has an inverted pyramid shape converging to a lowermost center formed with said drainage arrangement.

29. The tray according to claim 26 wherein said base is divided into at least four seed germination tray sub-areas.
